(19) United States
(12) Patent Application Publication
(10) Pub. No.: US 2023/0347760 A1
(43) Pub. Date: Nov. 2, 2023

(54) ELECTRICAL CONNECTOR FOR VEHICLE CHARGING INLET

(71) Applicant: Aptiv Technologies Limited, St. Michael (BB)

(72) Inventors: Robert ZIEMBA, Krakow (PL); Marek MLECZKO, Krakow (PL); Monika PIESZKA-LYSON, Krakow (PL)

(21) Appl. No.: 18/142,214

(22) Filed: May 2, 2023

(30) Foreign Application Priority Data
May 2, 2022 (EP) 22171083.3

(51) Int. Cl. B60L 53/16; H01R 13/66; B60L 53/302; H01R 13/52; H01R 43/00

(52) U.S. Cl. CPC B60L 53/16; H01R 13/6683; B60L 53/302; H01R 13/5202; H01R 43/005

(57) ABSTRACT

The electrical connector comprises at least one contact terminal, a printed circuit board on which at least one thermal sensor is mounted to monitor the temperature of the at least one contact terminal, at least one thermal conductive pad that includes at least one first thermal contact surface in direct engagement with the at least one contact terminal, and a second thermal contact surface in direct engagement with the at least one thermal sensor, to transfer heat from the at least one contact terminal to the at least one thermal sensor, and a support device for the at least one thermal conductive pad. The at least one thermal conductive pad is compressed between the support device and the printed circuit board by a force of compression causing the at least one first thermal contact surface to press against the at least one contact terminal and the second thermal contact surface to deform on the thermal sensor covering the thermal sensor.

### CROSS-REFERENCE TO RELATED APPLICATION

This application claims benefit of priority to European Patent Application No. 22171083.3 filed on May 2, 2022, the entire disclosure of which is hereby incorporated by reference.

### TECHNICAL FIELD OF THE INVENTION

The present disclosure relates to an electrical connector for connection to a mating electrical connector. Such an electrical connector can be part of an onboard charging inlet in a battery-powered electric vehicle (BEV) or plug-in hybrid electric vehicle (PHEV).

### BACKGROUND

A battery-powered electric vehicle (BEV), or a plug-in hybrid electric vehicle (PHEV), is equipped with a charging inlet. For charging the battery, the vehicle charging inlet can be connected to a grid socket through a charging cable having on one end, a power plug that is plugged to the grid socket, and, on the other end, a vehicle connector that fits the onboard charging inlet. A high charging current flows through the charging equipment, which results in a high thermal power dissipation. For safety reasons, it is required to monitor the temperature, for example in the onboard charging inlet and/or in the vehicle connector, to detect any overheating. In case an important rise of temperature is detected, the charging current can be reduced or switched off.

WO 2020/039344 A1 discloses an electrical connector including a housing provided with channels for contact terminals, and a temperature sensor assembly for monitoring the temperature of the terminals. The temperature sensor assembly includes a sealing pad having holes for receiving the contact terminals and a thermal shunt. The thermal shunt is received in a shunt bushing of the sealing pad. The sealing pad is thermally conductive and is thermally coupled to the contact terminals and to the thermal shunt. The terminal shunt is in contact with a thermal sensor. The thermal sensor monitors the temperature of the contact terminals via a thermal path defined by the sealing pad and the thermal shunt. The thermal shunt is a solid body, separate and discrete from the sealing pad. It is manufactured separately from a highly thermally conductive material such as an aluminum oxide material, aluminum nitride, mullite, a thermally conductive plastic, a metal material (e.g., copper or aluminum), or a ceramic material. The sealing pad is manufactured from an elastomer material, such as a silicone rubber.

The sealing pad disclosed in WO 2020/039344 A1 forms part of the thermal path between the terminals and the temperature sensor. It has two functions: a sealing function to prevent water from entering a rear chamber of the electrical connector from the front side, and a thermal conductor function to flow the heat from the terminals to the temperature sensor. The silicone rubber is known to provide a good sealing function. However, silicone is a poor thermal conductor. To improve its thermal conductivity, additional ingredients need to be added to the silicone. As a result, the silicone material may become more brittle, and the sealing pad is likely to be damaged during the assembling process. The silicon-based material is too brittle and may cause sealing lamellas breakage.

Therefore, there is a need to improve the situation. In particular, there is a need to avoid any damage during the manufacture of the electrical connector.

### SUMMARY

The present disclosure concerns an electrical connector including at least one contact terminal, a printed circuit board on which at least one thermal sensor is mounted to monitor the temperature of the at least one contact terminal, at least one thermal conductive pad that includes at least one first thermal contact surface in direct engagement with the at least one contact terminal, and a second thermal contact surface in direct engagement with the at least one thermal sensor, to transfer heat from the at least one contact terminal to the at least one thermal sensor, and a support device for the at least one thermal conductive pad. The at least one thermal conductive pad is compressed between the support device and the printed circuit board by a force of compression causing the at least one first thermal contact surface to press against the at least one contact terminal and the second thermal contact surface to deform on the thermal sensor covering the thermal sensor.

The thermal path between the thermal sensor(s) and the contact terminals is ensured by the thermal conductive pad that is a specific, independent or separate element for transferring heat from the contact terminal to the thermal sensor. The role of the thermal conductive pad is uniquely to transfer heat from the contact terminal to the thermal sensor.

Advantageously, the printed circuit board extends through a plane and the force of compression is orthogonal to the plane of the printed circuit board.

In an embodiment, the support device for the at least one thermal conductive pad is a sealing pad provided with at least one hole for receiving the at least one contact terminal and has a higher thermal conductivity than the sealing pad, and the thermal conductive pad is compressed between the sealing pad and the printed circuit board.

The thermal conductive pad and the sealing pad are two distinct elements or bodies. The sealing pad has a function of sealing, while the thermal conductive pad has a function of thermal bridge between the terminal(s) and the thermal sensor(s). The sealing pad does not need to have any thermal function for heat transfer. Therefore, it can be manufactured from a standard seal material, such as a standard silicone rubber, and be robust against breakage during the manufacture of the electrical connector.

The thermal conductive pad can be compressed between the sealing pad and a printed circuit board on which the at least one thermal sensor is mounted, a force of compression causing the at least one first thermal contact surface to press against the at least one contact terminal and the second thermal contact surface to deform on the thermal sensor covering the thermal sensor.

Thanks to the compression, each terminal is stably connected to a respective first thermal contact surface of the thermal conductive pad, and the second thermal contact surface deforms on the thermal sensor and covers it. The thermal sensor is immersed into the thermal conductive pad.

In WO 2020/039344 A1, the thermal path between the contact terminals and the thermal sensor includes a solid body to solid body connection between the temperature sensor and the thermal shunt. The thermal shunt only touches a top surface of the thermal sensor. As a result, the thermal contact between the thermal sensor and the shunt is limited. Furthermore, there may be a risk of damaging the thermal sensor by pressing the solid thermal shunt against its top surface. As the thermal shunt is a rigid body (e.g., metal or ceramic), it has its own mass that can vibrate during car driving. This may eventually cause micro cracks of the sensor's solder joints to the printed circuit board. In the present disclosure, the thermal contact between the thermal sensor and the thermal conductive pad is improved and the risk of damage to the thermal sensor is reduced.

In an embodiment, the thermal conductive pad is designed to slightly protrude into a passage of the at least one contact terminal received in the at least one hole of the sealing pad.

The thermal conductive pad is designed so that, before insertion of the terminal(s), a part of the thermal conductive pad including the first thermal contact surface(s) is sticking to, or protrudes into, the respective passages of the terminals. In this way, when the terminal(s) is/are inserted into the respective hole(s) of the sealing pad, the sticking or protruding part is pushed, moved, by the terminal(s) to ensure a stable connection between the terminal(s) and the thermal conductive pad. This allows to reduce the contact resistance between the terminal(s) and the thermal conductive pad.

Advantageously, the sealing pad has first positioning elements cooperating with second positioning elements of the thermal conductive pad to position the thermal conductive pad on the sealing pad.

For example, the first positioning elements and the second positioning elements include M protruding elements and M respective holes arranged to receive the M protruding elements.

In an embodiment, the thermal conductive pad has at least one beveled surface arranged between the at least one first thermal contact surface and an adjacent surface extending in a plane perpendicular to the first thermal contact surface, to avoid damage of the thermal conductive pad when the at least one contact terminal is inserted through the at least one hole of the sealing pad.

The beveled or chamfer surface allows to facilitate the insertion of the terminal(s) during manufacture, without damaging the thermal conductive pad.

The electrical connector may comprise a housing having a front part and a rear part. The at least one contact terminal is coupled to the housing and has, at one end, a contact pin disposed at the front of the housing, and, at the other end, a cable connector, disposed at the rear of the housing. The sealing pad, the at least one thermal conductive pad, and the at least one thermal sensor are received in the housing, at the rear. The sealing pad is arranged to prevent water from entering the rear part of the housing from the front part of the housing.

The electrical connector may further include a retainer for a printed circuit board on which the at least one thermal sensor is mounted, that is coupled to the housing at the rear.

In an embodiment, the thermal conductive pad may be compressed or sandwiched between, on one side, the sealing pad and, on the other side, the printed circuit board and the printed circuit board retainer, or PCB retainer, and the thermal conductive pad has a rear face including the second thermal contact surface to which the printed circuit board applies a compression force and a recess surface to which the printed circuit board retainer applies another compression force.

In a first embodiment, the electrical connector may include two contact terminals and one thermal conductive pad having two first thermal contact surfaces in direct engagement with the two contact terminals, respectively.

Alternatively, the thermal conductive pad, or each thermal conductive pad, may have one thermal contact surface to be put in direct engagement with one contact terminal.

In a second embodiment, the electrical connector further includes a third contact terminal and a ground terminal and another thermal conductive pad having two first thermal contact surfaces in direct engagement with the third contact terminal and the ground terminal, respectively.

The present disclosure also concerns a charging inlet device for a vehicle, including the electrical connector previously defined and a vehicle including an electric battery and a charging inlet device as above defined to charge the electric battery.

The present disclosure further concerns a method of manufacturing an electrical connector comprising at least one contact terminal, including the steps of:
providing a printed circuit board provided with at least one hole for receiving the at least one contact terminal and on which at least one thermal sensor is mounted to monitor the temperature of the at least one contact terminal;
providing a thermal conductive pad having at least one first thermal contact surface and a second thermal contact surface, and coupling the thermal conductive pad to a support device provided with at least one hole for receiving the at least one contact terminal;
coupling the printed circuit board to the assembly of the at least one thermal conductive pad and the support device, by causing the second thermal contact surface of the at least one thermal conductive pad to come into direct engagement with the at least one thermal sensor mounted on the printed circuit board;
exerting a force of compression to compress the at least one thermal conductive pad between the support device and the printed circuit board and cause the at least one first thermal contact surface to move to a path of the at least one contact terminal and the second thermal contact surface to deform on the thermal sensor covering the thermal sensor; and
inserting the at least one contact terminal into the at least one hole of the printed circuit board and into the at least one hole of the support device, by causing the at least one contact terminal to come into direct engagement with the at least one first thermal contact surface of the at least one thermal conductive pad.

In an embodiment, the support device is a sealing pad for receiving the at least one contact terminal.

### BRIEF DESCRIPTION OF THE DRAWINGS

The present invention is now described, by way of example with reference to the accompanying drawings, in which:

FIG. 1 shows a schematic view of a vehicle with a charging inlet connected to a power source through a charging cable;

FIG. 2 shows an exploded view of an electrical connector, according to an embodiment;

FIG. 3 shows an isometric view of a sealing pad coupled to a thermally conductive pad, according to a first embodiment;

FIG. 4 shows a rear view of the assembly of FIG. 3 with terminals introduced in holes provided in the sealing pad;

FIG. 5A shows an isometric view of a thermally conductive pad, according to the first embodiment;

FIG. 5B shows a rear view of the thermally conductive pad, according to the first embodiment;

FIG. 5C shows a front view of the thermally conductive pad, according to the first embodiment;

FIG. 6 shows an isometric view of the sealing pad, according to the first embodiment;

FIG. 7 shows an isometric view of a sealing pad coupled to a thermally conductive pad, according to a second embodiment;

FIG. 8 shows a rear view of the assembly of FIG. 6 with terminals introduced in holes provided in the sealing pad;

FIGS. 9A to 12B illustrate a process of assembling the electrical connector, according to the first embodiment;

FIG. 13 schematically illustrates the thermally conductive pad being compressed between the sealing pad and a printed circuit board with a thermal sensor mounted on it, according to the first embodiment; and

FIG. 14 is a flowchart of the process of assembling the electrical connector, according to the first embodiment.

### DETAILED DESCRIPTION

The following detailed description describes various features and functions of the disclosed devices, systems and methods with reference to the accompanying figures. In the figures, similar symbols identify similar components or elements, unless context dictates otherwise. The illustrative device, system and method embodiments described herein are not meant to be limiting. It may be readily understood by those skilled in the art that certain aspects of the disclosed devices, systems and methods can be arranged and combined in a wide variety of different configurations, all of which are contemplated herein.

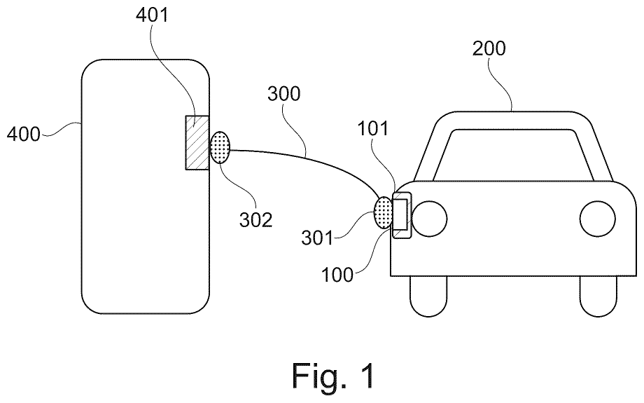

The present disclosure concerns an electrical connector 100. The electrical connector 100 may be included in a charging inlet device of a vehicle 200, for example a battery-powered electric vehicle (BEV), or a plug-in hybrid electric vehicle (PHEV), as shown in FIG. 1.

The charging inlet device may include the electrical connector 100 and means for mounting the electrical connector 100 to the vehicle. The electrical connector 100 is configured to mate a charging connector 301 of a charging cable 300 used to connect the onboard charging inlet device to a power source 400 for charging, for example to a grid socket. The charging cable 300 may be connected to a socket outlet 401 of the power source 400 via a plug 302, as shown in FIG. 1.

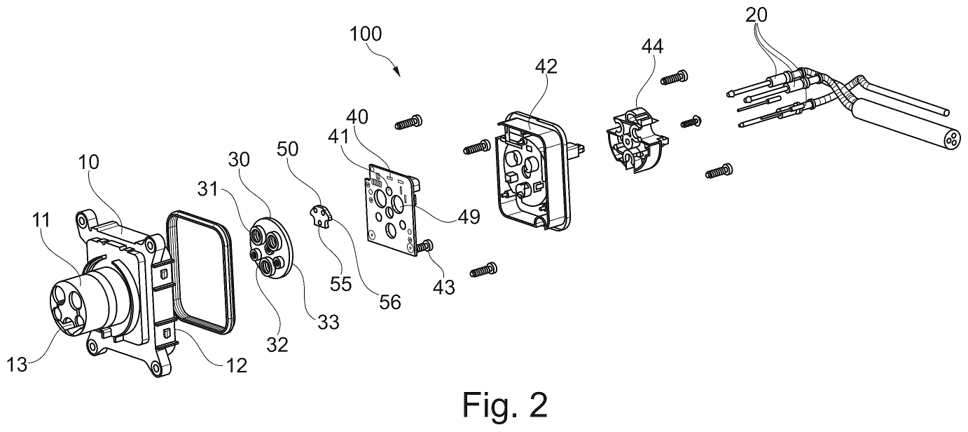

The electrical connector 100 has one or more contact terminals 20, or pins, coupled to, or assembled with, a main housing 10, as shown in FIG. 2.

### First Embodiment

In a first embodiment illustrated in FIG. 2, the electrical connector 100 has three contact terminals 20. For example, the electrical connector 100 is a Type 1 connector or a CCS combo 1 connector based on the standard CCS (Combined Charging System), also known as a CCS1 connector or inlet.

An electrical connector of Type 1 or CCS1 can be a 1-phase (AC Level 1) or 2-phase (AC Level 2) connector depending on the charging infrastructure.

In the first embodiment, the connector 100 is of Type 1 or CCS1 and has three contact terminals 20. It may be either a 1-phase connector or a 2-phase connector. In case of a 1-phase connector, the connector 100 includes the following contacts: L1 (phase), N (neutral), and PE (ground). In case of a 2-phase connector, the connector 100 includes the following contacts: L1 (phase), L2 (phase), and PE (ground). The terminals for which temperature may be checked are:
for the 1-phase connector (AC Level 1): terminals L1 and N; and
for the 2-phase connector (AC Level 2): terminals L1 and L2

As illustrated in FIG. 2, the main housing 10 extends between a front and a rear. It has a front part 11, a rear part 12 and terminal paths, or channels, 13 extending between the front and the rear with the terminals 20 in the terminal paths. The front part 11 is open towards the front of the main housing 10. For example, the front part 11 has a tower open towards the front of the main housing 10, receiving the front-end portions of the terminals 20. The rear part 12 may include a rear chamber.

Each terminal 20 has a contact pin at a front end, arranged in the front part 11 of the housing 10, and, at a rear end, a cable connector arranged at the rear of the main housing 10 and connected to a cable. In the first embodiment, the terminals 20 L1 and L2 (for a 2-phase connector)—or L1 and N (for a 1-phase connector)—are connected to a power battery via on-board charger to be charged and the ground terminal 20 is connected to the vehicle chassis, through respective cables. The terminals 20 are parallel to each other along a longitudinal axis.

In the first embodiment, the electrical connector 100 also includes a seal, or sealing pad, 30 for preventing water, and/or dust, from entering the rear part, or rear chamber, 12 of the main housing 10 from the front part, or front tower, 11 of the main housing 10, as illustrated in FIG. 2.

The sealing pad 30 may be in one single piece. For example, the sealing pad 30 may be a disk-shaped body. However, it could have any other shape.

The sealing pad 30 has a front face 32 and a rear face 33, respectively facing the front and the rear of the main housing 10.

The sealing pad 30 also has terminal holes 31 for receiving the terminals 20. The number of terminal holes 31 correspond to the number of contact terminals 20. In the first embodiment illustrated in FIGS. 1-2, the sealing pad 30 has three holes for receiving the three contact terminals 30. The sealing pad 30 may extend in a plane orthogonal to the longitudinal axis of the terminals 20.

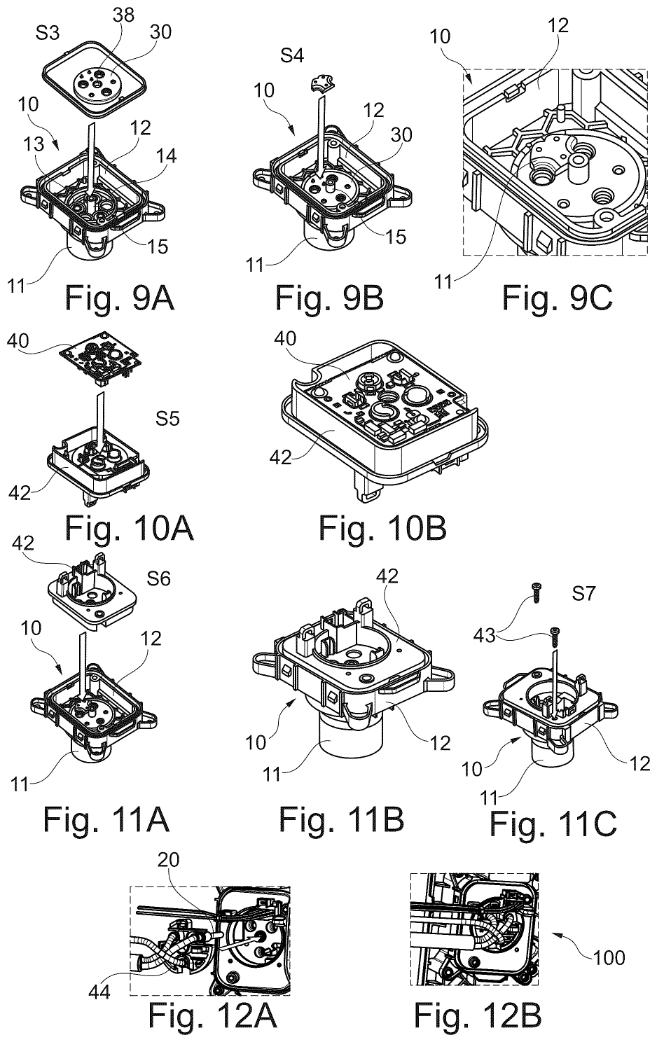

The sealing pad 30 is coupled to, or assembled with, the main housing 10. It is sealed to the main housing 10. For example, it may be received in a sealing pad housing 14 provided in the rear chamber 12 of the main housing 10, represented in FIG. 9A, and have an outer peripheral surface in direct engagement with an inner wall of the sealing pad housing 14, for example by means of compressible ribs provided on the sealing pad 30.

The sealing pad 30 is electrically insulative. It may be made of a soft and/or elastic material to ensure the sealing function. The sealing pad 30 may be manufactured from a silicone material, such as a silicone rubber. For example, the sealing pad is manufactured by processing a Liquid Silicone Rubber (LSR), that is a liquid silicone material, through an injection molding process. High Temperature Vulcanized Silicone Rubber (HTV) may also be used for the sealing pad 30. The inner surface of each hole 31 receiving a contact terminal 20 may have compressible ribs for sealing to the terminals 20.

The electrical connector 100 further includes a temperature monitoring system for monitoring the temperature of the contact terminals 20. A charging current may be controlled depending on the temperature of the contact terminals 20. In case that an important rise of temperature is detected, the charging current may be reduced or even switched off.

The temperature monitoring system includes at least one thermal sensor 41 and at least one thermal conductive pad 50. The one or more thermal sensors 41 are mounted on a printed circuit board 40. The printed circuit board 40 is provided with holes 49 for receiving the contact terminals 20.

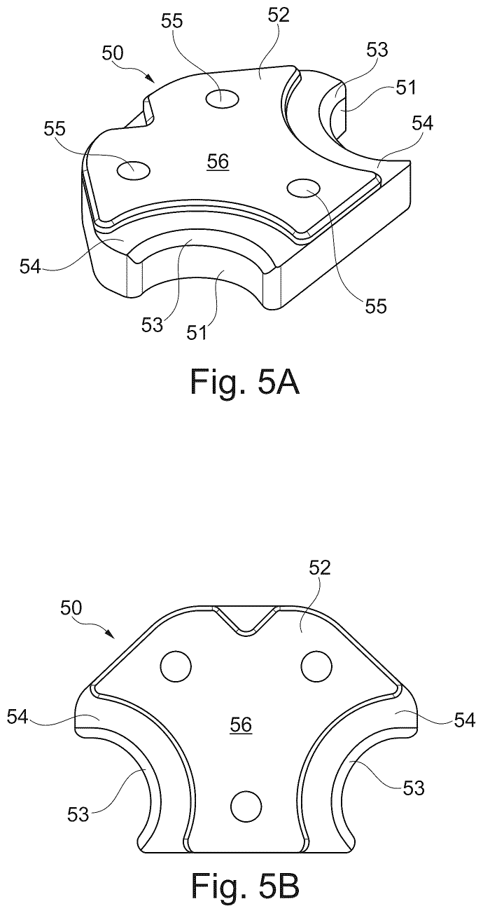

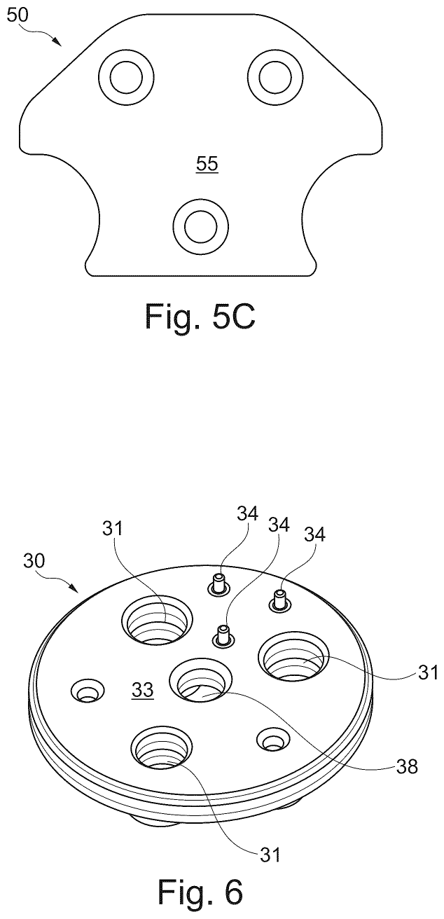

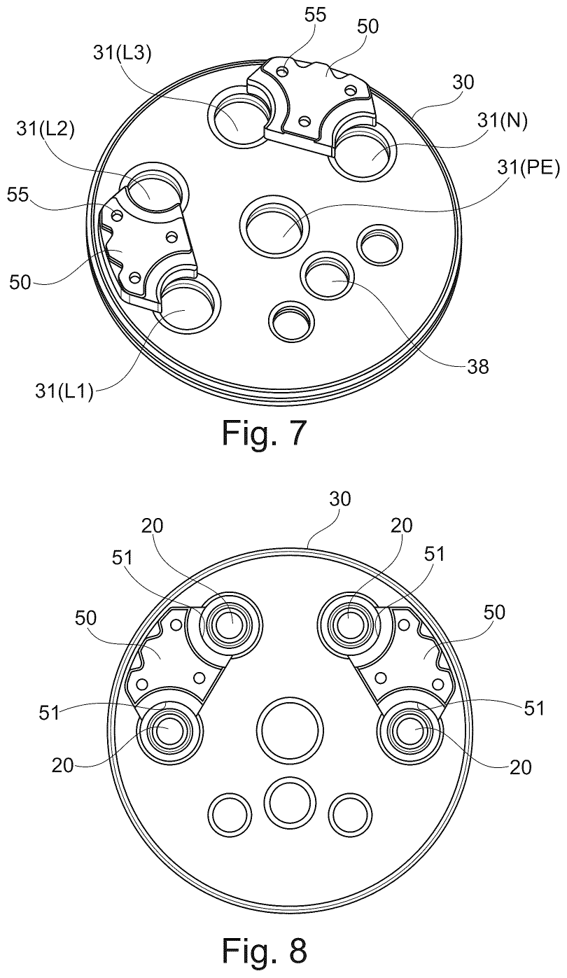

In the first embodiment, the temperature monitoring system has one thermal sensor 41 for monitoring the temperature of the two contact terminals 20 and one thermal conductive pad 50 illustrated in FIGS. 5A-5C.

Alternatively, the temperature monitoring system may have two thermal sensors 41 for monitoring the temperatures of the two respective contact terminals 20, and one thermal conductive pad 50.

The thermal conductive pad 50 is distinct from the sealing pad 30. In other words, the thermal conductive pad 50 and the sealing pad 30 are two distinct or discrete pads or bodies. They are manufactured as two separate pieces.

The thermal conductive pad 50 is manufactured from a thermally conductive and electrically insulative material. It has a higher thermal conductivity than other parts of the electrical connector 100 including the sealing pad 30, the housing 10, etc. . . . . Furthermore, the material of the thermal conductive pad 50 may be compressible and deformable. It may have a hardness of the Shore A scale. For example, the thermal conductive pad 50 may be manufactured from a material including silicone with one or more additional substance(s) to increase its thermal conductivity (i.e., its property that determines how much heat will flow in the material) and its thermal diffusivity (i.e., its property that determines how rapidly heat will flow within the material). The thermal conductivity of the pad 50 may be greater than or equal to 1 W/mK, for example within the range between 1 W/mK and 3 W/mK. Illustrative and non-limitative examples of a material for the thermal conductive pad 50 include the products NL9330 with hardness of 30 Shore A, NL9360 with hardness of 60 Shore A, NL9371 with hardness of 71 Shore A and HTV SC1230TC with hardness of 60 Shore A manufactured by the company Momentive Performance Materials Inc. Alternatively, it may be manufactured from other thermally conductive and electrically insulative materials.

In the first embodiment, the thermal conductive pad 50 is coupled to the sealing pad 30. The sealing pad 30 thus assumes the role of support device for the thermal conductive pad 50. The thermal conductive pad 50 is positioned adjacent to the at least one terminal hole 31, for example on a periphery of it.

The thermal conductive pad 50 has a front face 55 and a rear face 56, respectively facing the front and the rear of the main housing 10. The front face 55 of the thermal conductive pad 50 may be pressed against the rear face 33 of the sealing pad 30, as described later.

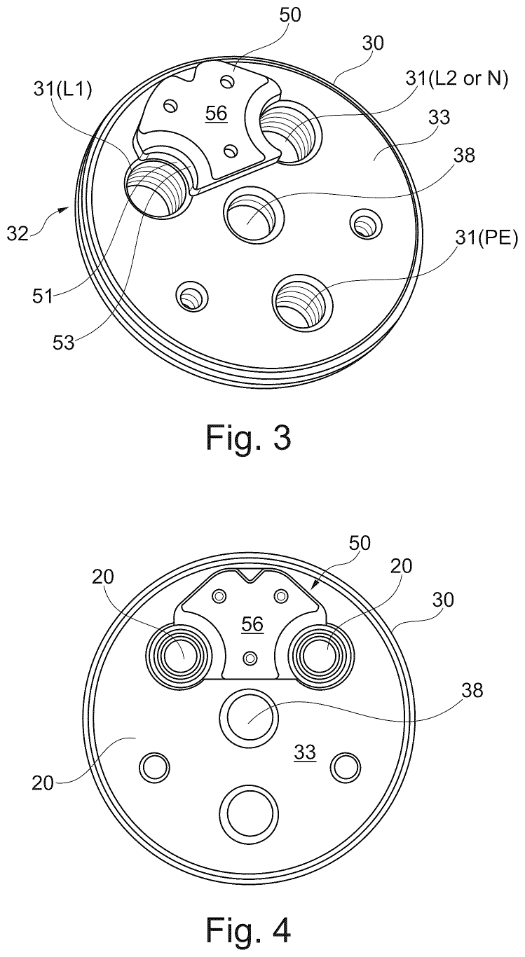

The thermal conductive pad 50 has one or more first thermal contact surface 51 and a second thermal contact surface 52, as shown in FIG. 3. Each first thermal contact surface 51 is in direct engagement, or direct contact, with one contact terminal 20. The second thermal contact surface 52 is in direct engagement, or in direct contact, with the thermal sensor 41. The second thermal contact surface 52 may be on the rear face 56 of the thermal conductive pad 50.

In the first embodiment, as illustrated in FIGS. 3-4, the thermal conductive pad 50 has two first thermal contact surfaces 51 in direct engagement with the two respective terminals 20 received in two adjacent holes 31 of the sealing pad 30, respectively. The thermal conductive pad 50 is disposed between these two holes 31 and is adjacent to them.

Alternatively, each thermal conductive pad 50 may have only one thermal contact surface 51 intended to be in direct engagement or contact with one terminal 20, and a second thermal contact surface 52 intended to be in direct engagement, or in direct contact, with the thermal sensor 41.

Each first thermal contact surface 51 may have a shape complementary to the shape of a portion of the terminal 20 against which the first thermal contact surface 51 is pressed. For example, the terminals 20 are cylindrical and the first thermal contact surfaces 51 are cylindrical portions.

Optionally, the thermal conductive pad 50 may be designed to slightly protrude into the passages or paths of the terminals 20, before insertion of the terminals 30 in the respective holes 31, to cause compression of the thermal conductive pad 50 by the terminals 20 during insertion in the respective holes 31 and thus improve the mechanical connection between the terminals 20 and the thermal conductive pad 50 when the terminals 20 are inserted in the respective holes 31, as explained later.

Optionally, the thermal conductive pad 50 may have a beveled surface 53 arranged between each first thermal contact surface 51 and a respective adjacent surface 54 on the rear face 56 of the thermal conductive pad 50. The surface 54 may extend in a plane perpendicular to the first thermal contact surface 51. The beveled surfaces 53 allow to avoid damage of the thermal conductive pad 50 when the terminals 20 are inserted through the holes 31 of the sealing pad 30 from rear to front.

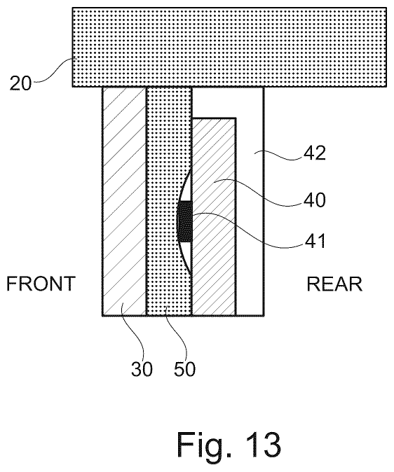

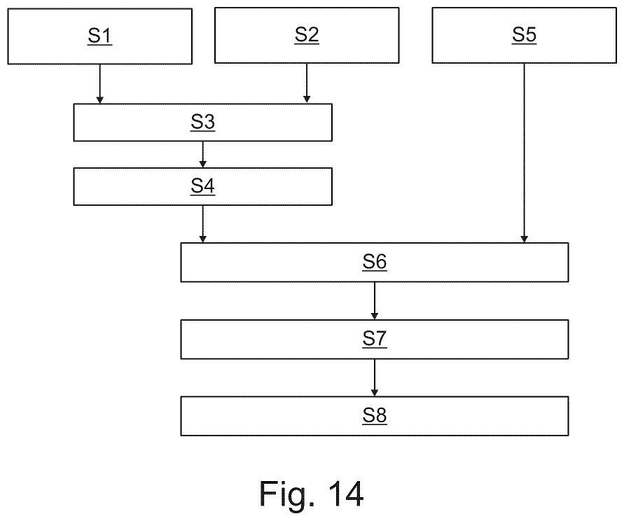

The thermal conductive pad 50 may be compressed between the sealing pad 30 and the printed circuit board 40 on which the thermal sensor 41 is mounted. Under the action of a compression force orthogonal to a plane of the PCB 40, the thermal conductive pad 50 is compressed and each first thermal contact surface 51 moves to the respective contact terminal 20 and the second thermal contact surface 52 deforms on the thermal sensor covering the thermal sensor 41, as schematically illustrated in FIG. 13.

In an embodiment, the printed circuit board 40 may be coupled to a retainer 42. The retainer 42 is provided with holes for receiving the contact terminals 20.

The thermal conductive pad 50 may be compressed between, on one side, the sealing pad 30 and, on the other side, the printed circuit board 40 and the printed circuit board retainer 42. The rear face 56 of the thermal conductive pad 50 may include the second thermal contact surface 52 in contact with the printed circuit board 40, and the surfaces 54, adjacent to the first thermal contact surface 51 and forming recess portions or grooves in the rear face 56. The printed circuit board 40 applies a force of compression onto the second thermal surface 52 and the retainer 42 applies another force of compression onto the recess surfaces 54. The grooves or recess surfaces 54 are designed so that an equal compression is applied on the thermal conductive pad 50 by the printed circuit board 40 and by the printed circuit board retainer 42.

Optionally, the sealing pad 30 has first positioning elements cooperating with second positioning elements of the thermal conductive pad 50 to position the thermal conductive pad 50 on the sealing pad 30. For example, the first positioning means and the second positioning means may include M protruding elements, or protrusions, 34 and M respective holes 55 arranged to receive the M protruding elements. The protruding elements 34 may be provided on the sealing pad 30 as shown in FIG. 6, here on the rear face 33 of the sealing pad 30, and the respective holes 55 may be provided in the thermal conductive pad 50. Advantageously, the number M may be equal to or above two, for example it is equal to three.

The process of manufacturing the electrical connector 100 of the first embodiment will now be described with reference to FIGS. 9-12, according to an embodiment.

The method has a step S1 of providing the main housing 10 and a step S2 of providing the sealing pad 30, as shown in FIG. 9A. Optionally, a peripheral seal 35 may also be provided in the step S2.

In a step S3, the sealing pad 30 is coupled to the main housing 10, as shown in FIG. 9A. The rear chamber 12 of the main housing 10 is open towards the rear and the sealing pad 30 is received in the sealing pad housing 14 in the rear chamber 12. As shown in FIG. 9A, the sealing pad 30 can be provided with an opening 38 for receiving a positioning pin 15 of the main housing 10, to facilitate the positioning of the seal 30 in the main housing 10. The rear face 33 of the sealing pad 30 is oriented towards the rear of the main housing 10. Optionally, in the step S3, the peripheral seal 35 is coupled to the main housing 10.

Then, the process includes a step S4 of providing the thermal conductive pad 50 and coupling the thermal conductive pad 50 to the sealing pad 30. The thermal conductive pad 50 is put on the rear face 33 of the sealing pad 30. It is disposed between the two holes 31 for receiving the two contact terminals respectively, adjacent to them. The protruding elements 34 of the sealing pad 30 are inserted into the corresponding holes 55 of the thermal conductive pad 50 to correctly position the thermal conductive pad 50 on the sealing pad 30. After coupling the thermal conductive pad 50 to the sealing pad 30, the first thermal contact surfaces 51 of the thermal conductive pad 50 slightly penetrate the respective paths or passages for the terminals 20. Alternatively, the thermal conductive pad 50 could be designed so that the first thermal contact surfaces 51 be disposed adjacent to the respective paths or passages for the terminals 20.

The process also includes a step S5 of providing the printed circuit board 40 on which the thermal sensor 41 is mounted. Furthermore, the step S5 may include assembling the printed circuit board 40 with the printed circuit board retainer 42, as shown in FIGS. 10A and 10B.

Then, in a step S6, the first assembly of the main housing 10, the sealing pad 30 and the thermal conductive pad 50 is coupled to the second assembly of the printed circuit board 40 and its retainer 42. In the step S6, the printed circuit board 40 held by the retainer 42 is introduced into the rear chamber 12, and, in a step S7, the printed circuit board retainer 42 is attached to the main housing 10, for example with screws 43.

During the assembling, in the step S7, the second thermal contact surface 52 of the thermal conductive pad 50 comes into direct engagement, or contact, with the thermal sensor 41 mounted on the printed circuit board 40, and a small force of compression is exerted, for example by turning the screws 43, to press the printed circuit board 40 against the assembly of the sealing pad 30 and the thermal conductive pad 50. Under the action of forces of compression, the thermal conductive pad 50 is compressed between the sealing pad 30 and the printed circuit board 40. As a result, the first thermal contact surfaces 51 of the thermal conductive pad 50 move to the paths of the contact terminals 20 and the second thermal contact surface 52 of the thermal conductive pad 50 deforms on the thermal sensor 40 covering the thermal sensor 41. This deformation of the thermal conductive pad 50 on the thermal sensor 41 is schematically illustrated in FIG. 13.

In a next step S8, the contact terminals 20 are assembled with a terminal holder 44 and introduced into the terminal channels or paths of the electrical connector 100, from the rear of the main housing 10 coupled to the assembly of the retainer 42 and the printed circuit board 40. When the contact terminals 20 are introduced into their respective paths, through the holes 49 of the PCB 40 and the holes 31 of the sealing pad 30, the contact terminals 20 come into contact and direct engagement with the respective first thermal contact surfaces 51 and push them back outside the terminal paths by compressing the thermal conductive pad 50, which results in a very stable mechanical connection between the terminals 20 and the respective first thermal contact surfaces 51. The beveled surfaces 53 facilitate the introduction of the terminals 20 and allows to avoid any damage of the thermal conductive pad 50.

In operation, when a high charging current is flowing through contact terminals 20, the heat dissipated by the terminals 20 is transferred from the terminals 20 to the thermal sensor 41 through the thermal conductive pad 50 that acts as a direct thermal bridge between the terminals 20 and the thermal sensor 41.

### Second Embodiment

A second embodiment of the electrical connector 100 only differs from the first embodiment in that the numbers of contact terminals 20, thermal conductive pads 50, and thermal sensors 41 are different. For example, the electrical connector of the second embodiment may be a connector of Type 2, or a CCS Combo 2 connector or inlet.

A Type 2 or CCS2 connector may be a 1-phase, 2-phase or 3-phase connector and include the following terminals:
for the 1-phase connector: terminals L1 and N;
for the 2-phase connector: terminals L1, L2 and N; and
for the 3-phase connector: terminals L1, L2, L3 and N.

In addition, the connector includes a ground terminal PE.

In the second embodiment, as illustrated in FIGS. 5 and 6, the electrical connector is a 3-phase connector of Type 2 or CCS2 having five contact terminals comprising three phase contacts (L1, L2, L3), one neutral contact (N) and one ground contact (PE). The five terminals L1, L2, L3, N, PE are received in five respective holes 31 provided in the sealing pad 30. The temperatures of the four contact terminals L1, L2, L3 and N may be monitored with temperature sensors.

In the second embodiment, the four monitored terminals 20 L1, L2, L3 and N are arranged in two pairs of terminals 20. Each pair of terminals is associated with one thermal conductive pad 50 and one thermal sensor 41. For each pair of terminals 20, the corresponding thermal conductive pad 50 is disposed on the sealing pad 30 between the two terminal holes 31, and adjacent to them, as shown in FIG. 8, and has two first thermal contact surfaces 51 in direct engagement with the two contact terminals 20 respectively, and a second thermal surface in direct engagement with the associated thermal sensor 41.

It should be noted that it may not be necessary to monitor the temperature of the ground terminal.

The process of manufacturing the electrical connector according to the second embodiment is analogous to the first embodiment.

The first and second embodiments are only illustrative examples. Any other configuration of electrical connector including P contact terminals, with P≥1, may be used. The numbers of thermal conductive pads and thermal sensors and their arrangement may be adapted to different configurations of electrical connector. For example, the temperature monitoring system may include one thermal sensor for two or more terminals, or one thermal sensor for one terminal.

The electrical connector of the present disclosure could be included in another charging device. For example, it could be included in the vehicle charging connector of a charging cable, or in a grid socket, or in a power source.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes”, “including”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector, comprising:
at least one contact terminal;
a printed circuit board on which at least one thermal sensor is mounted to monitor a temperature of the at least one contact terminal;
at least one thermal conductive pad that includes at least one first thermal contact surface in direct engagement with the at least one contact terminal, and a second thermal contact surface in direct engagement with the at least one thermal sensor, to transfer heat from the at least one contact terminal to the at least one thermal sensor; and
a support device for the at least one thermal conductive pad, wherein the at least one thermal conductive pad is compressed between the support device and the printed circuit board by a force of compression causing the at least one first thermal contact surface to press against the at least one contact terminal and the second thermal contact surface to deform on the thermal sensor covering the thermal sensor.

2. The electrical connector according to claim 1, wherein the printed circuit board extends through a plane and the force of compression is orthogonal to the plane of the printed circuit board.

3. The electrical connector according to claim 1, wherein the support device for the at least one thermal conductive pad is a sealing pad provided with at least one hole for receiving the at least one contact terminal and has a higher thermal conductivity than the sealing pad, and the thermal conductive pad is compressed between the sealing pad and the printed circuit board.

4. The electrical connector according to claim 3, wherein the at least one thermal conductive pad is designed to slightly protrude into a passage of the at least one contact terminal received in the at least one hole of the sealing pad.

5. The electrical connector according to claim 3, wherein the sealing pad has first positioning elements cooperating with second positioning elements of the at least one thermal conductive pad to position the at least one thermal conductive pad on the sealing pad.

6. The electrical connector according to claim 5, wherein the first positioning elements and the second positioning elements include M protruding elements and M respective holes (55) arranged to receive the M protruding elements.

7. The electrical connector according to claim 3, wherein the at least one thermal conductive pad has at least one beveled surface arranged between the at least one first thermal contact surface and an adjacent surface extending in a plane perpendicular to the first thermal contact surface, to avoid damage of the at least one thermal conductive pad when the at least one contact terminal is inserted through the at least one hole of the sealing pad.

8. The electrical connector according to claim 3, comprising a housing having a front part and a rear part, wherein the at least one contact terminal is coupled to the housing and has, at one end, a contact pin disposed at the front of the housing, and, at another end, a cable connector, disposed at the rear of the housing, wherein the sealing pad, the at least one thermal conductive pad, and the at least one thermal sensor are received in the housing, at the rear and wherein the sealing pad is arranged to prevent water from entering the rear part of the housing from the front part of the housing.

9. The electrical connector according to claim 8, wherein the at least one thermal conductive pad is sandwiched between, on one side, the sealing pad and, on the other side, the printed circuit board and a retainer for the printed circuit board retainer, that is coupled to the housing at the rear, and the at least one thermal conductive pad has a rear face including the second thermal contact surface in contact with the printed circuit board and a recess surface in contact with the retainer for the printed circuit board.

10. The electrical connector according to claim 1, including two contact terminals and one thermal conductive pad having two first thermal contact surfaces in direct engagement with the two contact terminals, respectively.

11. A charging inlet device for a vehicle, including the electrical connector according to claim 1.

12. A vehicle including an electric battery and a charging inlet device according to claim 11 to charge the electric battery.

13. A method of manufacturing an electrical connector comprising at least one contact terminal, including the steps of:
providing a printed circuit board provided with at least one hole for receiving the at least one contact terminal, and on which at least one thermal sensor is mounted to monitor a temperature of the at least one contact terminal;
providing a thermal conductive pad having at least one first thermal contact surface and a second thermal contact surface, and coupling the thermal conductive pad to a support device provided with at least one hole for receiving the at least one contact terminal;
coupling the printed circuit board to an assembly of the at least one thermal conductive pad and the support device, by causing the second thermal contact surface of the at least one thermal conductive pad to come into direct engagement with the at least one thermal sensor mounted on the printed circuit board;
exerting a force of compression to compress the at least one thermal conductive pad between the support device and the printed circuit board and cause the at least one first thermal contact surface to move to a path of the at least one contact terminal and the second thermal contact surface to deform on the thermal sensor covering the thermal sensor; and
inserting the at least one contact terminal into the at least one hole of the printed circuit board and into the at least one hole of the support device, by causing the at least one contact terminal to come into direct engagement with the at least one first thermal contact surface of the at least one thermal conductive pad.

14. The method according to claim 13, wherein the support device is a sealing pad for receiving the at least one contact terminal.
